(19) United States
(12) Patent Application Publication
(10) Pub. No.: US 2003/0043934 A1
(43) Pub. Date: Mar. 6, 2003

(54) System and method for applying delay codes to pulse train signals

(76) Inventor: Mark D. Roberts, Huntsville, AL (US)

Correspondence Address: Robert S. Babayi, VENABLE, P.O. Box 34385, Washington, DC, 20043-9998, US

(21) Appl. No.: 09/878,923

(22) Filed: Jun. 13, 2001

(51) Int. Cl. H04L 27/04; H04L 27/12; H04L 27/20; H04L 27/06; H04L 27/14; H04L 27/22

(52) U.S. Cl. 375/316; 375/295

(57) ABSTRACT

A method and system for applying delay codes to pulse train signals is provided. The delay codes vary the time offset between asynchronous pulse train signals to eliminate persistence of pulse coincidences. The pulse train signal may comprise a repeating pulse train. The delay codes specify delays between individual pulse trains or some number of pulse trains. The delay codes result in an averaging of pulse coincidences between the pulse train signals over time. Additionally, the delay codes may be generated using a pseudorandom code generation technique.

### CROSS-REFERENCE TO OTHER APPLICATIONS

The following applications of common assignee may contain common disclosure with the present application:

U.S. patent application Ser. No. 09/638,192 entitled “A METHOD FOR SPECIFYING NON-TEMPORAL PULSE CHARACTERISTICS”, filed on Aug. 15, 2000 (Attorney Docket No. 28549-165559).

U.S. patent application Ser. No. 09/638,046 entitled “A METHOD AND APPARATUS FOR APPLYING CODES HAVE PREDEFINED PROPERTIES”, filed on Aug. 15, 2000 (Attorney Docket No. 28549-165552).

U.S. patent application Ser. No. 09/637,878 entitled “A METHOD AND APPARATUS FOR POSITIONING PULSES USING A LAYOUT HAVING NON-ALLOWABLE REGIONS”, filed on Aug. 15, 2000 (Attorney Docket No. 28549-165553).

U.S. patent application Ser. No. 09/638,150 entitled “A METHOD AND APPARATUS FOR POSITIONING PULSES IN TIME”, filed on Aug. 15, 2000 (Attorney Docket No. 28549-165554).

U.S. patent application Ser. No. 09/638,151 entitled “A METHOD AND APPARATUS FOR MAPPING PULSES TO A NON-FIXED LAYOUT”, filed on Aug. 15, 2000 (Attorney Docket No. 28549-165555).

U.S. patent application Ser. No. 09/638,152 entitled “A METHOD AND APPARATUS FOR SPECIFYING PULSE CHARACTERISTICS USING CODE THAT SATISFIES PREDEFINED CRITERIA”, filed on Aug. 15, 2000 (Attorney Docket No. 28549-165556).

U.S. patent application Ser. No. 09/638,153 entitled “A METHOD FOR SPECIFYING PULSE CHARACTERISTICS USING CODES”, filed on Aug. 15, 2000 (Attorney Docket No. 28549-165557).

U.S. patent application Ser. No. 09/638,154 entitled “A METHOD FOR SPECIFYING NON-ALLOWABLE PULSE CHARACTERISTICS”, filed on Aug. 15, 2000 (Attorney Docket No. 28549-165558).

U.S. patent application Ser. No. 09/708,025 entitled “A METHOD AND APPARATUS FOR GENERATING A PULSE TRAIN WITH SPECIFIABLE SPECTRAL RESPONSE CHARACTERISTICS”, filed on Nov. 8, 2000 (Attorney Docket No. 28549-165402).

The above-listed applications are incorporated herein by reference in their entireties.

### FIELD OF THE INVENTION

The present invention relates to impulse transmission systems and, more particularly, to a system and method of applying delay codes for positioning pulse trains in time.

### BACKGROUND OF THE INVENTION:

As the availability of communication bandwidth in the increasingly crowded frequency spectrum is becoming a scarce and valuable commodity, Ultra Wideband (UWB) technology provides an excellent alternative for offering significant communication bandwidth, particularly, for various wireless communications applications. Because UWB communication systems are based on communicating extremely short-duration pulses (e.g., pico-seconds in duration), such systems are also known as impulse radio systems. Impulse radio systems were described in a series of patents, including U.S. Pat. Nos. 4,641,317 (issued Feb. 3, 1987), 4,813,057 (issued Mar. 14, 1989), 4,979,186 (issued Dec. 18, 1990), and 5,363,057 (issued Nov. 8, 1994) to Larry W. Fullerton, and U.S. Pat. Nos. 5,677,927 (issued Oct. 14, 1997), 5,687,169 (issued Nov. 11, 1997), and 5,832,035 (issued Nov. 3, 1998) to Larry W. Fullerton, et al. These patents are incorporated herein by reference.

Multiple access impulse radio systems are different from conventional Code Division Multiple Access (CDMA), Time Division Multiple Access (TDMA) and Frequency Division Multiple Access (FDMA) systems. Unlike such systems, which use continuous sinusoidal waveforms for transmitting information, a conventional impulse radio transmitter emits a low power electromagnetic train of short pulses, which are shaped to approach a Gaussian monocycle. As a result, the impulse radio transmitter uses very little power to generate noise-like communication signals for use in multiple-access communications, radar and positioning applications, among other things. In the multi-access communication applications, the impulse radio systems depend, in part, on processing gain to achieve rejection of unwanted signals. Because of the extremely high achievable processing gains, the impulse radio systems are relatively immune to unwanted signals and interference, which limit the performance of systems that use continuous sinusoidal waveforms. The high processing gains of the impulse radio systems also provide much higher dynamic ranges than those commonly achieved by the processing gains of other known spread-spectrum systems.

Impulse radio communication systems transmit and receive the pulses at precisely controlled time intervals, in accordance with a time-hopping code. As such, the time-hopping code defines a communication channel that can be considered as a unidirectional data path for communicating information at high speed. In order to communicate the information over such channels, impulse radio transmitters may use position modulation, which is a form of time modulation, to position the pulses in time, based on instantaneous samples of a modulating information signal. The modulating information signal may for example be a multi-state information signal, such as a binary signal. Under this arrangement, a modulator varies relative positions of a plurality of pulses on a pulse-by-pulse basis, in accordance with the modulating information signal and a specific time-hopping code that defines the communication channel.

In applications where the modulating information signal is a binary information signal, each binary state may modulate the time position of more than one pulse to generate a modulated, coded timing signal that comprises a train of identically shaped pulses that represent a single data bit. The impulse transmitter applies the generated pulses to a specified transmission medium, via a coupler, such as an antenna, which electromagnetically radiates the pulses for reception by an impulse radio receiver. The impulse radio receiver typically includes a single direct conversion stage. Using a correlator, the conversion stage coherently converts the received pulses to a baseband signal, based on a priori knowledge of the time-hopping code. Because of the correlation properties of the selected time-hopping codes, the correlator integrates the desired received pulses coherently, while the undesired noise signals are integrated non-coherently such that by comparing the coherent and non-coherent integration results, the impulse receiver can recover the communicated information.

Conventional spread-spectrum code division multiple access (SS-CDMA) techniques accommodate multiple users by permitting them to use the same frequency bandwidth at the same time. Direct sequence CDMA systems employ pseudo-noise (PN) codewords generated at a transmitter to “spread” the bandwidth occupied by transmitted data beyond the minimum required by the data. The conventional SS-CDMA systems employ a family of orthogonal or quasi-orthogonal spreading codes, with a pilot spreading code sequence synchronized to the family of codes. Each user is assigned one of the spreading codes as a spreading function. One such spread-spectrum system is described in U.S. Pat. No. 4,901,307 entitled SPREAD-SPECTRUM MULTIPLE ACCESS COMMUNICATION SYSTEM USING SATELLITE OR TERRESTRIAL REPEATERS by Gilhousen et al. incorporated herein by reference.

Unlike direct sequence spread-spectrum systems, the time-hopping code for impulse radio communications is not necessary for energy spreading, because the monocycle pulses themselves have an inherently wide bandwidth. Instead, the impulse radio systems use the time-hoping codes for channelization, energy smoothing in the frequency domain, and interference suppression. The time-hoping code defines a relative position of each pulse within a group of pulses, or pulse train, such that the combination of pulse positions defines the communications channel. In order to convey information on such communication channel, each state of a multi-state information signal may vary a relative pulse position by a predefined time shift such that a modulated, coded timing signal is generated comprising a train of pulses, each with timing corresponding to the combination of the time position coding and the multi-state modulation. Alternative modulation schemes such as pulse amplitude modulation or pulse width modulation may also be used in place of or in combination with pulse position modulation.

In one conventional binary approach, pulses are time-modulated forward or backward about the nominal pulse positions specified by a time-hopping code. More specifically, each pulse is time modulated by adjusting its position within a time frame to one of two possible times about a nominal position specified by a code element of a time-hopping code. For example, in order to send a “0” binary bit during a time frame, the pulse may be offset from a nominal position of the time frame by about −50 picoseconds. For a “1” binary state, the pulse may be offset from the nominal position by about +50 picoseconds.

In practice, impulse radio systems typically employ distinctive time-hopping codes known to have suitable autocorrelation and cross-correlation properties to support signal acquisition and channelization. The cross-correlation between any two time-hopping codes should be low for minimal interference between multiple users in a communications system or between multiple target reflections in radar and positioning applications. At the same time, the autocorrelation property of a time-hoping code should be steeply peaked, with small side-lobes. Maximally peaked time-hopping code autocorrelation yields optimal acquisition and synchronization properties for communications, radar and positioning applications.

Various coding schemes that produce families of codes having desirable correlation properties are available. For example, Quadratic Congruential (QC) codes, Hyperbolic Congruential (HC) codes and optical codes have been used in impulse radio systems. Generally, based on known assumptions, such coding schemes guarantee a maximum limit to the number of pulse coincidences, i.e., hits, for any defined time frame or time frame shift during which the codes are repeated. For example, for any two codes selected from a family of QC codes, no more than a maximum of four cross-correlation coincidences will occur.

McCorkle in U.S. Pat. No. 5,847,677 discloses a random number generator for generating a pseudorandom code for use with jittered pulse repetition interval radar systems. The code is generated by a random number generator that possesses certain attributes desirable for a jittered radar. As disclosed, the attributes relate to a flat frequency spectrum, a nearly perfect spike for an autocorrelation function, a controllable absolute minimum and maximum interval, long sequences that do not repeat, and a reasonable average pulse rate.

One known coding technique for an impulse radio is disclosed by Barrett in U.S. Pat. No. 5,610,907, entitled ULTRAFAST TIME-HOPPING CDMA-RF COMMUNICATIONS: CODE-AS-CARRIER, MULTICHANNEL OPERATION, HIGH DATA RATE OPERATION AND DATA RATE ON DEMAND. According to the disclosed techniques, two levels of coding are used: major orthogonal codes are applied to provide channelization, and forward error correction (FEC) codes are applied to information data before transmission. The disclosed system relies on dividing time into repetitive time layouts comprising super-frames, frames and subframes. As disclosed, a super-frame corresponds to a time interval representing one instance, or period, of a code. The super-frame is evenly divided into a number of frames that are evenly subdivided into a number of subframes into which pulses are positioned based on the major orthogonal code.

When using time-hopping codes, as described above, the number of pulse coincidences that would occur between two repeating pulse trains arriving at a receiver greatly depends on the time offset between them. FIG. 1 depicts pulse coincidences occurring as two repeating pulse trains 10 and 12 arrive asynchronously at a receiver. The first pulse train 10 represents an intended signal and the second pulse train 12 represents a non-intended, or interfering, signal. The two pulse trains 10 and 12 are each comprised of seven pulses 10a-10g and 12a-12g positioned in time according to two different time-hopping codes mapped to a common time layout. As shown, the pulse trains 10 and 12 are offset from each other by a time offset X, which represents the difference in the reference times of the time layouts for the two pulse trains 10 and 12. In this example, the pulses 10c and 12c and pulses 10e and 12e of the two pulse trains 10 and 12 arrive simultaneously, thereby coinciding with each other at the receiver. Consequently, coherent detection of pulses received at one receiver may be subject to interference by coinciding pulses of a different asynchronously generated pulse train, for example, one that is intended for another receiver. It should be noted that the number of pulse coincidences that occur between the two arriving pulse trains would persist over time as the pulse trains repeat.

Ideally, there should be no pulse coincidences between pulses of asynchronously communicated pulse trains arriving at a receiver. It should be further appreciated that for a given time offset between two pulse train signals arriving at a receiver, the number of pulse coincidences may be as little as zero. But, for a different time offset, the number of pulse coincidences may be as high as the maximum number of coincidences that is specified by correlation properties of the time-hopping codes used to position pulses of the pulse trains in time. Thus, even when using time-hopping codes selected for their superior correlation properties, the received signal quality of impulse radio systems can vary greatly as a result of the asynchronous time offsets of received signals. Since it is generally desirable that impulse radio systems operating within close proximity have comparable channelization performance, there is a need to provide a consistent level of signal quality within impulse radio systems that use time-hopping codes to specify the time positioning of pulse trains.

### SUMMARY OF THE INVENTION

Briefly, the present invention relates to pulse trains, with each pulse train comprising pulses having predefined temporal and non-temporal characteristics. A temporal pulse characteristic specifies pulse position in time, and a non-temporal pulse characteristics specifies pulse amplitude, width, polarity, type, etc. The pulses of each pulse train are positioned in time in accordance with a time-hopping code having code elements that specify pulse positions within a defined time layout. The number of code elements, which may be expressed in terms of code element values, define the pulse positions for a single pulse train during a time-hopping code period that is repeated to produce repeating pulse trains.

The present invention adjusts the time offset between asynchronously generated pulse trains to avoid pulse coincidences that may occur at a receiver. In one embodiment of the invention, at least one time delay is inserted between two pulse trains, for example, after or before a time-hopping code period. A time delay can be specified by a code element of a delay code that is generated using a known numerical code generation technique, for example, a pseudorandom code generation technique. In accordance with another embodiment, the insertion of the time delays can be nested such that after a number of pulse trains, which are delayed with a first time delay, a second time delay is inserted to further adjust the time offset between asynchronously generated pulse trains. More specifically, according to the nested delay code feature of the present invention, a second delay code comprising one or more code elements may be used to specify time delays after a number or a group of first delay code periods. Under this embodiment, each of the first delay code periods corresponds to a plurality of time-hopping code periods and corresponding time delays as specified by a first delay code. For example, code elements of a first delay code can specify time delays after time-hopping code periods, or groups of time-hopping code periods, and code elements of a second delay code can specify time delays after delay code periods, or groups of delay code periods. Furthermore, delay codes can be nested to as many levels as desired.

In accordance with one of the more detailed features of the present invention, the delays are inserted to improve received signal quality. Under this arrangement, the delays are inserted to find an optimum time offset (relative to the original time-layout reference) that produces a received signal quality measure, which satisfies a predefined quality criterion. According to one embodiment, received signal quality values are determined for a plurality of received pulse train signals. The delays are inserted or otherwise adjusted until the optimum time offset that satisfies the predefined received signal quality criterion is found. Preferably, at least one of the pulse train signals is positioned in time in accordance with a time layout that sets a time reference relative to which the delays are inserted for finding the optimum time offset. If the time delay is specified by a code element of a delay code, the delay code (and its elements) are varied or otherwise changed to satisfy the predefined received signal quality criterion. The optimum time offset is then determined based on a found delay code that produces a desired received signal quality.

In one exemplary embodiment, when a received signal quality value satisfies the predefined received signal quality criterion, two transceivers coordinate the ceasing of the usage of the delay code and the delaying of a pulse train signal by an amount of time equal to the sum of the time delays that positions the pulse train signal in time such that the received signal quality value satisfies the predefined received signal quality criterion. Thus, this sum of time delays is used relative to the original time layout reference to specify the optimum time offset for generating the pulse trains. Similarly, in another exemplary embodiment, the best received signal quality value is determined from among measured received signal quality values for a plurality of received pulse train signals. Afterwards, the two transceivers coordinate a delay of a pulse train by an amount of time equal to the sum of the time delays that position the pulse train in time corresponding to the best received signal quality value. A received signal quality value can be a function of signal strength, bit-error-rate, or signal-to-noise ratio or some combination of the same. Alternatively, a received signal quality value may pertain to a spectral property of the received signal. Moreover, for either of these embodiments, whenever it is determined that a received signal quality criterion is no longer satisfied, transceivers can coordinate further use of a delay code in order to find a time delay that provides more desirable performance. Alternatively, a delay code can be employed periodically in order to find a time delay that provides more desirable performance.

As described in further detail below, the present invention improves channelization consistency of impulse radio systems operating in close proximity by causing the time offset between received pulse train signals to vary over time and thereby preventing the persistence of pulse coincidences. Additionally, by causing the time offset between received pulse train signals to vary over time, the average number of pulse coincidences per code period approaches the average correlation of the time-hopping codes used to specify the time positioning of the received pulse train signals, which approaches zero as the average pulse repetition interval (PRI) increases. Furthermore, by enabling impulse radio systems to be designed for average correlation performance while accommodating the occasional occurrence of an undesired number of pulse coincidences per code period, the current invention enables the use of larger families of time-hopping codes having less-restrictive correlation properties, e.g., pseudorandom codes. Accordingly, the current invention significantly increases the number of usable time-hopping codes.

The current invention also enables an impulse radio system to dynamically adapt the timing of its pulse train signal to optimize received signal performance. This dynamic signal timing approach supports time-hopping code reuse by enabling multiple systems operating within close proximity to use the same time-hopping code but with different time offsets. By dynamically determining optimal time offsets, unacceptable numbers of pulse coincidences that are possible with lesser quality time-hopping codes can be avoided. In this way, the present invention significantly increases the number of usable time-hopping codes.

Furthermore, the use of delay codes, for example, pseudorandom delay codes, reduces the periodicity of repeating pulse train signals resulting in energy smoothing in the frequency domain. Additional energy smoothing can be achieved by nesting two or more delay codes.

As will be understood by someone skilled in the art, the current invention may be similarly employed to improve the channelization consistency of other forms of time-varied signals like those used in frequency hopping, Time-Division Multiple Access (TDMA), Time-Division—Code Division Multiple Access (TD-CDMA), Orthogonal Frequency Division Multiple Access (OFDM), and other such multiple access systems. Such signals are typically varied in accordance with a time-varying code, for example a TD-CDMA code, which varies a characteristic of the signals in time, for example the frequency of the signals, in a manner similar to a time-hopping code.

### BRIEF DESCRIPTION OF THE DRAWINGS:

FIG. 1 illustrates pulse coincidences between two asynchronously generated pulse trains.

FIG. 2 is a block diagram of a transmitter used in accordance with the present invention.

FIG. 3 is a block diagram of a receiver used in accordance with the present invention.

FIG. 4a illustrates applying a delay code to a coded signal in accordance with one embodiment of the present invention.

FIG. 4b illustrates pulse coincidences between two pulse train signals varying as a result of using delay codes in accordance with one embodiment of the present invention.

FIG. 5 depicts generation of a family of quadratic congruential codes.

FIG. 6 illustrates cross-correlation properties of the 6^{th} channel code relative to the 5^{th} channel code of FIG. 5.

FIG. 7 is an exemplary plot diagram for illustrating the number of coincidences against a time offset in the example of FIG. 6.

FIG. 8a illustrates two pulse train signals having pulse coincidence persistence.

FIG. 8b illustrates applying delay codes to the two pulse train signals of FIG. 8a in accordance with another embodiment of the present invention.

FIG. 9 illustrates nested delay codes applied to a pulse train signal in accordance with yet another embodiment of the present invention.

FIG. 10 is a flow diagram for optimizing received signal quality using delay codes in accordance with another aspect of the present invention.

### DETAILED DESCRIPTION OF THE INVENTION

I. Overview Exemplary Impulse Radio System

A. Transmitter

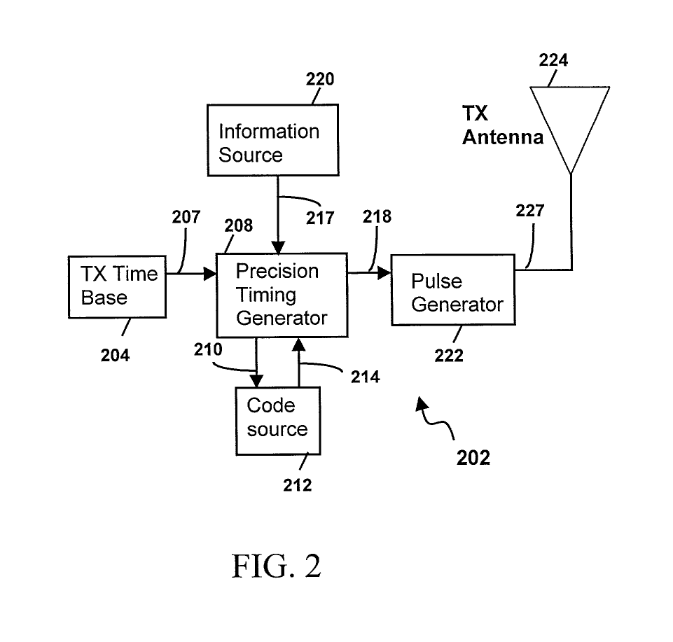

Referring to FIG. 2, an exemplary embodiment of an impulse radio transmitter 202 of an impulse radio communication system having one subcarrier channel that advantageously employs the present invention is shown.

The transmitter 202 comprises a time base 204 that generates a periodic timing signal 207. The time base 204 typically comprises a voltage controlled oscillator (VCO), or the like, having a high timing accuracy and low jitter, on the order of picoseconds (ps). The voltage control to adjust the VCO center frequency is set at calibration to the desired center frequency used to define the transmitter's nominal pulse repetition rate. The periodic timing signal 207 is supplied to a precision timing generator 208.

The precision timing generator 208 supplies synchronizing signals 210 to the code source 212 and utilizes the code source output 214 together with an internally generated subcarrier signal (which is optional) and an information signal 217 to generate a modulated, coded timing signal 218.

The code source 212 comprises a storage device such as a random access memory (RAM), read only memory (ROM), or the like, for storing suitable time-hopping codes and for outputting the time-hopping codes as a code signal 214. Alternatively, maximum length shift registers or other computational means can be used to generate the time-hopping codes, as further described below.

An information source 220 supplies the information signal 217 to the precision timing generator 208. The information signal 217 can be any type of intelligence, including digital bits representing voice, data, imagery, or the like, analog signals, or complex signals.

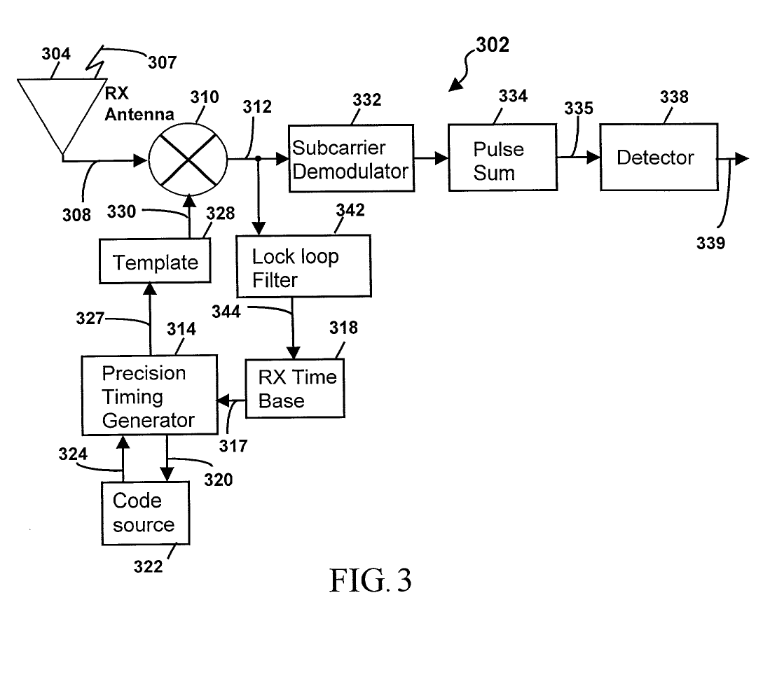

A pulse generator 222 uses the modulated, coded timing signal 218 as a trigger to generate output pulses. The output pulses are sent to a transmit antenna 224 via a transmission line 227 coupled thereto. The output pulses are converted into propagating electromagnetic pulses by the transmit antenna 224. In the present embodiment, the electromagnetic pulses are called the emitted signal, and propagate to an impulse radio receiver 302, such as shown in FIG. 3, through a propagation medium, such as air, in a radio frequency embodiment. In a preferred embodiment, the emitted signal is wide-band or ultrawide-band, approaching a monocycle pulse.

However, the emitted signal can be spectrally modified by filtering of the pulses. This filtering will usually cause each monocycle pulse to have more zero crossings (more cycles) in the time domain. In this case, the impulse radio receiver can use a similar waveform as the template signal in a cross correlator for efficient conversion.

B. Receiver

FIG. 3 shows an exemplary embodiment of an impulse radio receiver 302 (hereinafter called the receiver) for the impulse radio communication that may be used in connection with the present invention. More specifically, the system illustrated in FIG. 3 is for reception of digital data wherein one or more pulses are transmitted for each data bit.

The receiver 302 comprises a receive antenna 304 for receiving a propagated impulse radio signal 307. A received signal 308 from the receive antenna 304 is coupled to a cross correlator or sampler 310 to produce a baseband output 312. The cross correlator or sampler 310 includes multiply and integrate functions together with any necessary filters to improved and optimize the received signal quality in accordance with the present invention.

The receiver 302 also includes a precision timing generator 314, which receives a periodic timing signal 317 from a receiver time base 318. This time base 318 is adjustable and controllable in time, frequency, or phase, as required by the lock loop in order to lock on the received signal 308. The precision timing generator 314 provides synchronizing signals 320 to the code source 322 and receives a code control signal 324 from the code source 322. The precision timing generator 314 utilizes the periodic timing signal 317 and code control signal 324 to produce a coded timing signal 327. The template generator 328 is triggered by this coded timing signal 327 and produces a train of template signal pulses 330 ideally having waveforms substantially equivalent to each pulse of the received signal 308. The code for receiving a given signal is the same code utilized by the originating transmitter 202 to generate the propagated signal 307. Thus, the timing of the template pulse train 330 matches the timing of the received signal pulse train 308, allowing the received signal 308 to be synchronously sampled in the correlator 310. The correlator 310 ideally comprises a multiplier followed by a short-term integrator to sum the multiplier product over the pulse interval.

Further examples and details of correlation and sampling processes can be found in commonly owned patents 4,641,317, 4,743,906, 4,813,057, and 4,979,186, which are incorporated herein by reference, and commonly owned and co-pending application 09/356,384, filed Jul. 16, 1999, titled: “BASEBAND SIGNAL CONVERTER DEVICE FOR A WIDEBAND IMPULSE RADIO RECEIVER,” which is incorporated herein by reference.

The output of the correlator 310, also called a baseband signal 312, is coupled to a subcarrier demodulator 332, which demodulates the subcarrier information signal from the subcarrier. The purpose of the optional subcarrier process, when used is to move the information signal away from DC (zero frequency) to improve immunity to low frequency noise and offsets. The output of the subcarrier demodulator 332 is then filtered or integrated in a pulse summation stage 334. The pulse summation stage 334 produces an output representative of the sum of a number of pulse signals comprising a single data bit. The output of the pulse summation stage 334 is then compared with a nominal zero (or reference) signal output in a detector stage 338 to determine an output signal 339 representing an estimate of the original information signal 317.

The baseband signal 312 is also input to a lowpass filter 342 (also referred to as lock loop filter 342). A control loop comprising the lowpass filter 342, time base 318, precision timing generator 314, template generator 328, and correlator 310 is used to generate a filtered error signal 344. The filtered error signal 344 provides adjustments to the adjustable time base 318 to time position the periodic timing signal 327 in relation to the position of the received signal 308.

In a transceiver embodiment, substantial economy can be achieved by sharing part or all of several of the functions of the transmitter 202 and receiver 302. Some of these include the time base 318, precision timing generator 314, code source 322, antenna 304, and the like.

II. Overview of the Invention

Generally, in a pulse transmission system, a pulse train comprising a sequence of pulses is transmitted and received in accordance with a time layout. The pulses are positioned in time in accordance with a time-hopping code that define a channel used by the system to transmit information. The time-hopping code includes code elements that specify the nominal position of each pulse in time.

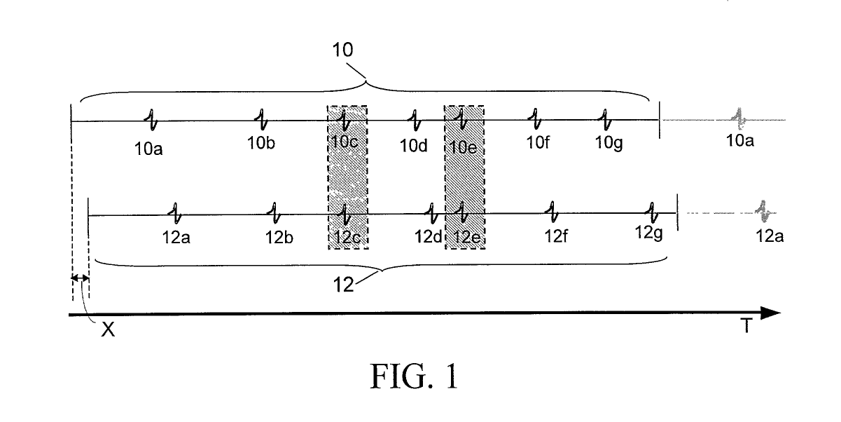

Referring back to FIG. 1, pulses 10a-10g and 12a-12g are positioned in time based on corresponding code elements of two time-hopping codes. In accordance with the time layout, the pulse trains 10 and 12 repeat over time such that the minimum time value of a time period containing a pulse train occurs at the same time as the maximum time value of the preceding time period containing the preceding pulse train. FIG. 1 depicts a time offset X between the pulse trains 10 and 12, which results in two pulses of pulse train 10 coinciding with two pulses of pulse train 12. The time offset between the two pulse trains determines the pulses that coincide, which may be none. Generally, pulse coincidences degrade received signal quality. Furthermore, since the two pulse trains repeat over code periods that are defined by the code length of the two time-hopping codes, and since the code periods are equal, the number of pulse coincidences between the two pulse trains persists as the pulse trains repeat. Thus, the degradation of received signal quality as a result of pulse coincidences persists.

In one exemplary embodiment, the present invention uses a delay code to cause the time offset between repeating pulse trains to vary over the code period. The code period is common to the time-hopping codes used to specify the relative positioning of the pulses in the pulse trains. As the time offset between the pulse trains varies over the code period, the number of pulse coincidences between the pulse trains also varies. Over time, the average number of pulse coincidences that occur per code period approaches the average correlation of the time-hopping codes.

A delay code comprises code elements that specify delays inserted after one or more instances of a pulse train that cause the time offset between the following one or more instances of the pulse train and another asynchronously generated pulse train signal to be varied by the amount of the delay. Thus, delay code elements specify delays between adjacent pulse trains or groups of pulse trains. In its simplest form, a delay code element specifies a period of time appended before or after a time-hopping code period. In either case, a delay specified by a delay code element represents a period of time between adjacent time-hopping code periods. It should be noted that due to the wraparound nature of repeating pulse trains, a time delay equal to the code period of the time-hopping code is the same as a zero time delay.

Various code generation techniques can be used to generate a delay code in accordance with the present invention. For example, a pseudorandom code generation technique, as described below, can be used to specify a delay code that would cause the time offset between two pulse trains arriving at a receiver to vary (pseudo) randomly between zero and the code period of the time-hopping codes used to specify the pulse positioning of the two pulse trains.

Thus, the present invention provides a method and system for inserting delays, for example, by applying delay codes, in order to control pulse coincidences of asynchronously generated repeating pulse train signals. The delay codes are applied to the pulse train signals in accordance with a defined time layout relative to which correlation properties of the applied time-hopping codes are defined. In this way, the delay codes vary the time offset between asynchronously generated pulse train signals arriving at a receiver to remove persistence of pulse coincidences between them. As such, over time the correlation between such asynchronously generated pulse train signals approaches an average coincidence value.

In one exemplary embodiment, the present invention may be used in a multiple access UWB communications system. However, in further embodiments, the invention may be used in other types of multiple access systems including frequency hopping, TDMA, TD-CDMA, and OFDM systems that utilize time-varied signals. With these embodiments, delay codes are applied to the time-varied signals that are specified by a time-varying code, for example a TD-CDMA code, which varies a characteristic of the signals in time, for example the frequency of the signals, in a manner similar to a time-hopping code.

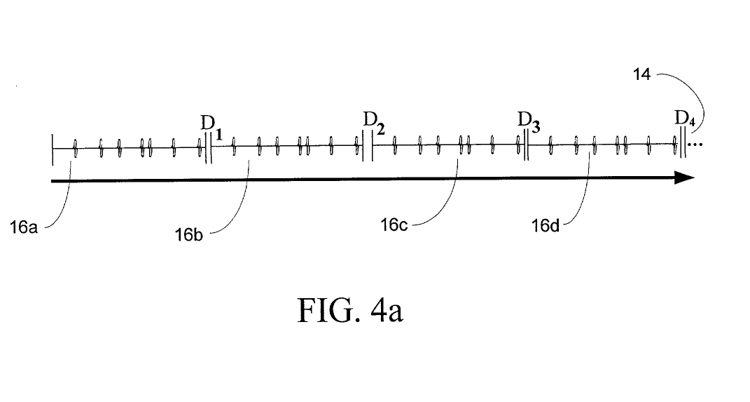

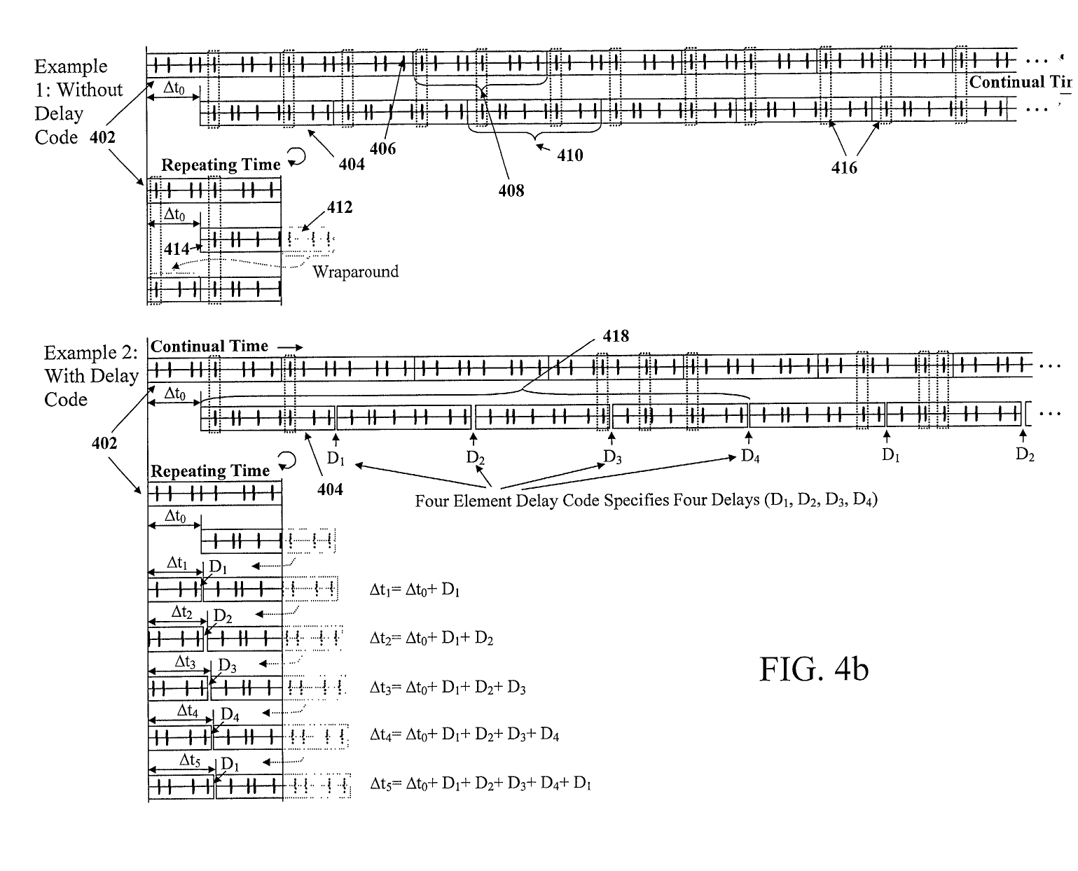

FIG. 4a illustrates a pulse train signal 14 including repeating pulse trains 16a-16d. In this example, each pulse train 16a-16d includes seven pulses positioned in time in accordance with code elements of a time-hopping code. The pulses are positioned throughout a code period that applies a selected time-hopping code having a code length of 7, which corresponds to the time-hopping code period. FIG. 4a shows the application of a delay code that inserts, appends, or otherwise adjusts or controls delays D₁-D₄ after pulse trains 16a-16d. The code elements of the delay code define the amount of the time delay inserted after the pulse trains. As stated above, the number of code elements of a delay code defines a delay code length. In one approach, the delay code length specifies the number of pulse trains to which the delay code elements are applied. For example, a delay code having 10 code elements, or a code length of 10, may specify delays after 10 pulse trains. Then, the delays can be repeated for the subsequent 10 pulse trains, and so on, in accordance with a delay code period. When a delay code is applied to pulse trains, the sum of the delays specified by the delay code elements and the combined duration of the pulse trains about which the delays are applied defines the delay code period.

Code elements of a delay code can specify delays after pulse train groups instead of delays after individual pulse trains. For example, a delay code having a code length of 10 can specify delays after 10 pulse train groups where each pulse train group is comprised of N pulse trains, where N is a predefined number. Furthermore, the number of pulse trains within pulse train groups may vary, for example, pseudorandomly, as long as both the transmitter and receiver know the number of pulse trains in each pulse train group. When a delay code is applied to pulse train groups, the sum of the delays specified by the delay code elements and the combined durations of the pulse trains in the pulse train groups about which the delays are applied defines the delay code period.

As shown in FIG. 4a, the application of the delay code to the pulse train signal 14 results in a delay D₁ after pulse train 16a, a delay D₂ after pulse train 16b, a delay D₃ after pulse train 16c, and a delay D₄ after pulse train 16d. As stated before, the durations of the delays D₁-D₄ are specified by corresponding delay code elements. Furthermore, the combination of the pulse trains and delays, or the delay code period, may repeat such that the next instance of pulse train 16a occurs after delay D₄, and so on.

The effects of using a delay code are illustrated in FIG. 4b, which compares the correlation of two repeating pulse train signals arriving at a receiver when a delay code is not used and when a delay code is used. In the two examples presented, correlation between the two repeating pulse train signals, which are assumed to be asynchronously generated, is shown first in continual time and then in repeating time. In continual time, the continuous nature of time is maintained. In repeating time, a reference time period is used to describe the repeating nature of the repeating pulse train signal. In example 1, a first pulse train 402 is comprised of eight pulses 406 positioned in time in accordance with a first time-hopping code having a code period 408. A second pulse train 404 is comprised of eight pulses 406 positioned in time in accordance with a second time-hopping code having a code period 410 that is equal to the code period 408 of the first time-hopping code. The two pulse trains repeat. As shown in continual time, multiple instances of the first pulse train 402 and multiple instances of the second pulse train 404 repeat contiguously such that the time offset, Δt₀, between the two repeating pulse train signals remains constant. As shown in repeating time, the code period 408 of the first pulse train 402 may be used as a reference time period such that the portion 412 of the second pulse train 404 that occurs after the reference time period wraps around in front of the portion 414 of the second pulse train 404 that begins during the reference time period. In this way, the timing of the pulses 406 in the second repeating pulse train 404 is shown relative to the timing of the pulses 406 in the first repeating pulse train 402 and the second pulse train 404 is shown as being offset from the first pulse train 402 by the constant time offset Δt₀. Similarly, the code period 410 of the second pulse train 404 could be used as the reference time period and the pulses 406 in the first repeating pulse train 402 could be shown relative to the timing of the pulses 406 in the second repeating pulse train 404.

In FIG. 4b, dotted rectangles around pulses 406 identify pulse coincidences 416 occurring between the two repeating pulse trains. Specifically, after startup, the first and fifth pulses 406 of each instance of the first pulse train 402 coincide with the sixth and first pulses 406 of consecutive instances of the second pulse train 404, respectively. Thus, example 1 depicts the persistence of the time relationships of the pulses 406 of the second pulse train 404 to the pulses 406 of the first pulse train 402 including persistent pulse coincidences 416 as a result of the time offset Δt₀ remaining constant between the two repeating pulse train signals.

In example 2 of FIG. 4b, the same two pulse trains 402, 404 used in the first example are shown where delays D₁-D₄ specified by a delay code having four delay code elements are inserted after instances of the pulse trains 404 defined by the second time-hopping code. Specifically, six complete instances and a partial instance of the second pulse train 404 are shown with the first delay D₁ inserted after the first instance, the second delay D₂ inserted after the second instance, the third delay D₃ inserted after the third instance, and the fourth delay D₄ inserted after the fourth instance. The first delay D₁ is also shown being inserted after the fifth instance and the second delay D₂ is also shown being inserted after the sixth instance, and so on, to illustrate how the use of a delay code can be repeated. Furthermore, the sum of the four delays D₁-D₄ and the code periods 410 of the four successive instances of the second pulse train 404 define the delay code period 418. As can be seen in example 2, the number of coincidences between the two pulse trains 402, 404 varies over time as a result of inserting the delays D₁-D₄ in accordance with the delay code elements of the delay code. Additionally, the time offset between instances of the two pulse trains varies with each delay. Specifically, the delay between the first two instances of the two pulse trains 402, 404 is equal to Δt₀, the delay between the second two instances of the two pulse trains 402, 404 is equal to Δt₁=Δt₀+D₁, the delay between the third two instances of the two pulse trains 402, 404 is equal to Δt₂=Δt₁+D₂, the delay between the fourth two instances of the two pulse trains 402, 404 is equal to Δt₃=Δt₂+D₃, the delay between the fifth two instances of the two pulse trains 402, 404 is equal to Δt₄=Δt₃+D₄, the delay between the sixth two instances of the two pulse trains 402, 404 is equal to Δt₅=Δt₄+D₁, and so on. In this way, the time offset between the two pulse trains 402, 404 continues to increase until it equals the reference time period, at which point the time offset is also zero due to the wraparound nature of repeating pulse trains, and the time offset continues to increase until it wraps around again to zero, and so on. Thus, example 2 depicts the varying of the time relationships of the pulses 406 of the second pulse train 404 to the pulses 406 of the first pulse train 402 including pulse coincidences 416 as a result of the delay code causing the time offset between the two pulse train signals to vary over time.

As can be seen in FIG. 4b, in order to eliminate persistence of pulse coincidences between two asynchronously generated pulse train signals arriving at a receiver, delay codes need only be used by one of the two impulse radio systems involved. If only one of the two impulse radio systems applies a delay code, the time offset between the two asynchronously generated pulse train signals varies across the code period, wraps around, varies across the code period, wraps around, and so on. Whereas, if both impulse radio systems apply delay codes, the time offset between the two pulse train signals can increase and decrease in a random-like manner, since a given delay inserted by one system can be larger, smaller, or the same as that of the other system. In either case, the average number of pulse coincidences over time approaches the average coincidence value provided by the correlation properties of the time-hopping codes used to specify the positioning of the pulse trains of the two signals. Accordingly, delay codes can be used by only one pulse transmission system comprising a transmitter and receiver pair, by a subset of multiple pulse transmission systems operating in close proximity, or by all pulse transmission systems operating in close proximity.

Delay codes can be used continuously or on an as needed basis. For example, a transmitter and receiver may coordinate the use of delay codes or the stopping, or suspending, of the use of delay codes based on a signal quality criterion. Alternatively, delay codes can be used for a predetermined amount of time. Thus, delay codes can be selectively used to minimally affect data rates.

Each pulse transmission system of a plurality of pulse transmission systems operating in close proximity can use a different delay code. Alternatively, each pulse transmission system of a plurality of pulse transmission systems operating in close proximity, or a subset, can use the same delay code. In either case, the time offsets between pulse train signals arriving at a receiver varies over time.

Delay codes may be produced independently from each other such that they have different delay code lengths and delay code periods. Alternatively, families of delay codes may be produced that have a common delay code length and/or a common delay code period. For example, families of delay codes may be generated where the sum of the delays for any delay code in the family is equal. The delay codes of such delay code families may also have a common delay code length, in which case they would also have a common delay code period when applied in the same manner to pulse trains or pulse train groups. Using this approach, multiple pulse transmission systems, each employing a delay code of a delay code family and a time-hopping code of a time-hopping code family, could maintain the same average pulse repetition rate and thus have the same data rate.

Generally, a delay code may specify any number of delays to be applied any number of times to any sequence of pulse trains or pulse train groups. Although the delays used in previous examples differ, it is possible that two or more delay code elements specify the same time delay. Furthermore, it is possible that a given delay code element specifies no time delay. Accordingly, a variety of different delay code permutations can be used to vary the relative timing of pulse trains over time to remove pulse coincidence persistence and thereby improve overall signal quality.

III. Time Layouts and Code Mapping

Like time-hopping codes, delay codes can be produced and used in a variety of ways. Typically, such codes consist of some number of code elements that map to either periods (or ranges) of time or to discrete time values within a defined time layout. A time layout can be configured in a multitude of ways to accommodate a wide variety of applications. One approach involves a value range layout where a period of time is divided into smaller and smaller components. The division is used to achieve a desired component resolution in order to facilitate mapping of a code element value to a time position that resides within a layout component, which corresponds to some range of time values. Another approach to defining a time layout is to specify discrete time positions to which individual code elements can map. With this approach, code elements map to exact time positions instead of to periods of time. For certain applications it may be advantageous to combine the value range layout and discrete time position approaches.

In conjunction with a given defined time layout, various code mapping approaches can be used to map the code elements of one or more codes, for example, time-hopping codes, delay codes, or combinations of such codes, to the time layout. Code elements of a code can be values, such as floating point values, representing time delay amounts, or code elements may be symbols, such as integers, that correspond to components or discrete time positions within a time layout.

Examples of various time layouts and various code mapping approaches are included in a co-owned patent application entitled “METHOD FOR SPECIFYING PULSE CHARACTERISTICS USING CODES”, U.S. patent application Ser. No. 09/638,153 (Attorney Docket No.: 28549-165557), which is hereby incorporated by reference. Examples of code combination approaches are included in a co-owned patent application entitled “A METHOD AND APPARATUS FOR APPLYING CODES HAVE PREDEFINED PROPERTIES”, U.S. patent application Ser. No. 09/638,046 (Attorney Docket No. 28549-165552), which is also hereby incorporated by reference.

IV. Numerical Code Generation

Various numerical code generation methods can be used to produce time-hopping codes to specify the time positioning of pulses in a pulse train. Each method produces time-hopping codes that, when employed, result in a pulse train having certain correlation and/or spectral properties, and therefore has advantages and disadvantages relative to the application(s) of the impulse transmission system employing the pulse train. Generally, time-hopping codes fall into one of two categories: designed codes and pseudorandom codes.

A designed time-hopping code may be generated using a quadratic congruential (QC), hyperbolic congruential, linear congruential, Costas array or other such numerical code generation technique designed to generate codes guaranteed to have certain correlation properties. Each of these alternative code generation techniques has certain characteristics to be considered in relation to the application of the pulse transmission system employing the code. For example, Costas codes have nearly ideal autocorrelation properties but somewhat less than ideal cross-correlation properties, while linear congruential codes have nearly ideal cross-correlation properties but less than ideal autocorrelation properties. In some cases, design tradeoffs may require that a compromise between two or more code generation techniques be made such that a code is generated using a combination of two or more techniques. An example of such a compromise is an extended QC code generation approach that uses two ‘independent’ operators, where the first operator is linear and the second operator is quadratic. Accordingly, one, two, or more designed code generation techniques or combinations of such techniques can be employed to generate a time-hopping code without departing from the scope of the invention.

A pseudorandom time-hopping code may be generated using a computer's random number generator, binary shift-register(s) mapped to binary words, a chaotic code generation scheme, or another well-known technique for generating seemingly random sequences. Such ‘random-like’ codes are attractive for certain applications since they tend to spread spectral energy over multiple frequencies while having ‘good enough’ correlation properties, whereas designed codes may have superior correlation properties but have spectral properties that may not be as suitable for a given application.

Computer random number generator functions commonly employ the linear congruential generation (LCG) method or the Additive Lagged-Fibonacci Generator (ALFG) method. Alternative methods include inversive congruential generators, explicit-inversive congruential generators, multiple recursive generators, combined LCGs, chaotic code generators, and Optimal Golomb Ruler (OGR) code generators. Any of these or other similar methods can be used to generate a pseudorandom time-hopping code without departing from the scope of the invention, as will be apparent to those skilled in the relevant art.

Detailed descriptions of the code generation techniques identified above are included in a co-owned patent application entitled “A METHOD AND APPARATUS FOR POSITIONING PULSES IN TIME”, U.S. patent application Ser. No. 09/638,150 (Attorney Docket No. 28549-165554) which is a Continuation-In-Part application for pending U.S. patent application Ser. No. 09/592,249, (Attorney Docket No. 28549-160074, which is hereby incorporated by reference. It should be noted that alternative methods for producing a code or codes to specify the time positioning of pulses in a pulse train could be employed without departing from the scope of the invention as would be understood by one skilled in the art.

V. Mapping Time Hopping Code Elements to Pulse Characteristics

After one or more time-hopping codes have been generated, the time positioning of pulses in a pulse train are established by mapping the generated code(s) to the defined time layout according to the desired mapping approach. If a value range layout was employed, an offset value may be used to specify an exact value within the value range of the component to which a given code element maps. In an exemplary embodiment, a code may be used to specify components in which to place pulses and an offset value may be used to position pulses in the center of, or at some other position within, the specified components.

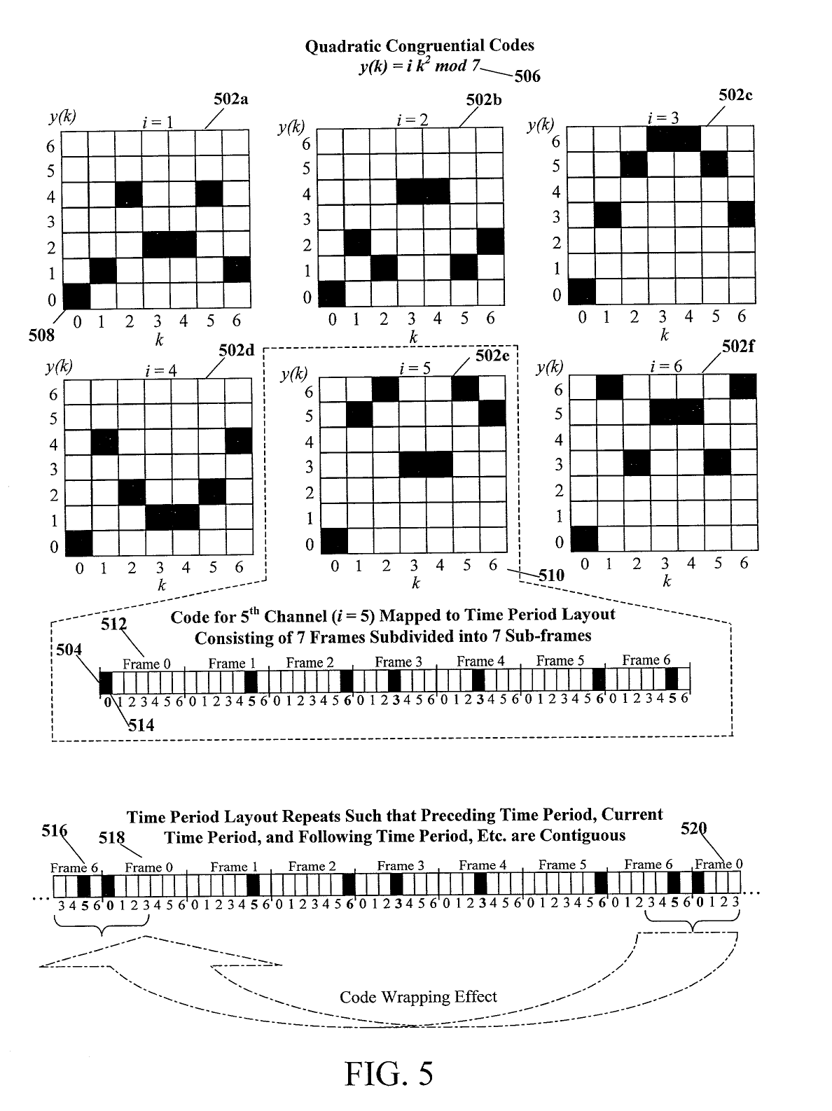

The following description provides a detailed example of the mapping of QC codes to a value range time layout such that the specified pulse train has certain desirable correlation properties. FIG. 5 depicts the generation of QC codes 502a-502f using a code generation equation, y(k)=i k² mod 7 (506). Six codes 502a-502f representing six channels are produced and displayed in matrix form where the darkened squares 508 represent code element values. Thus for channels i=1 to 6, the six codes 502a-502f presented are {0,1,4,2,2,4,1}, {0,2,1,4,4,1,2}, {0,3,5,6,6,5,3}, {0,4,2,1,1,2,4}, {0,5,6,3,3,6,5}, and {0,6,3,5,5,3,6}. The outlined region 510 about the 5^{th} code 502e (i=5) illustrates how the code 502e maps to a time layout 504 consisting of seven components 512, or frames, where each frame 512 is subdivided into seven subcomponents 514, or subframes. Each column k maps to a frame 512 and the row y(k) highlighted for each column k represents the subframe 514 y(k) in which to place a pulse. The bottom of the figure illustrates how the time layout repeats. As shown, the last frame of a preceding time layout 516 is contiguous with the first frame of a current time layout 518 and the last frame of the current time layout 518 is contiguous with the first frame of the following time layout 520. Thus, whenever the start of a time layout 518 is shifted in time by some offset, a code wrapping effect occurs.

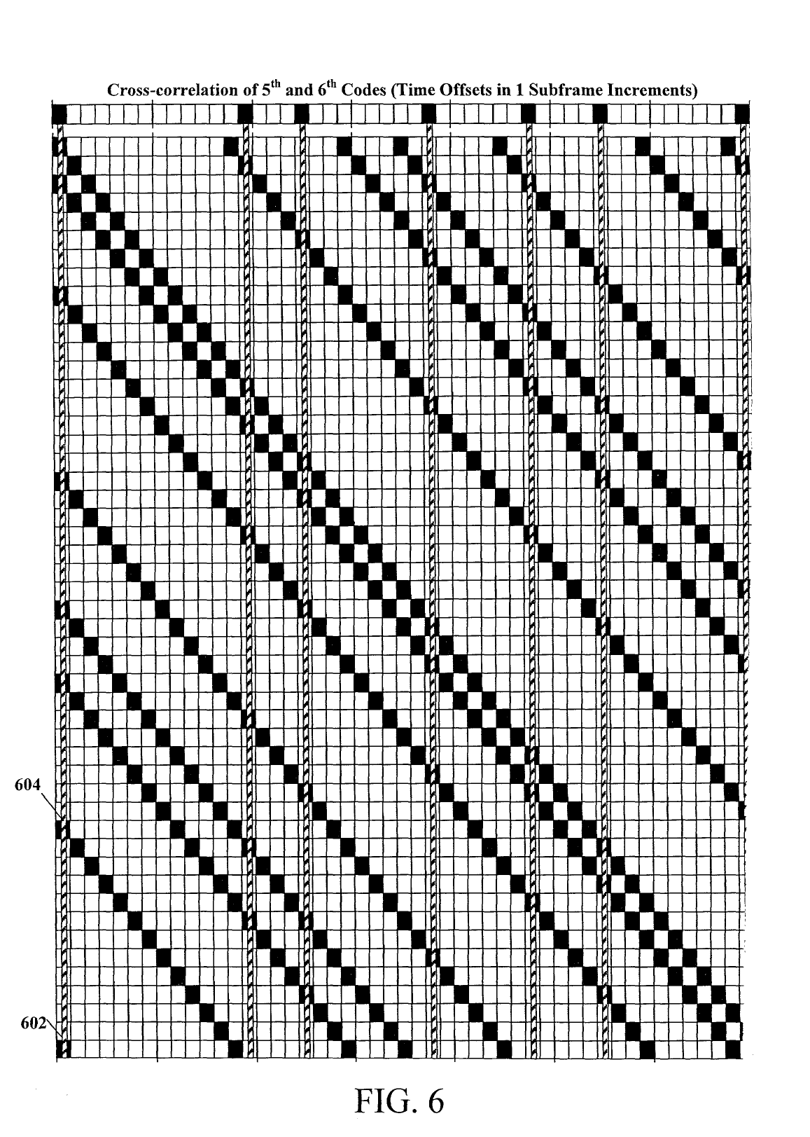

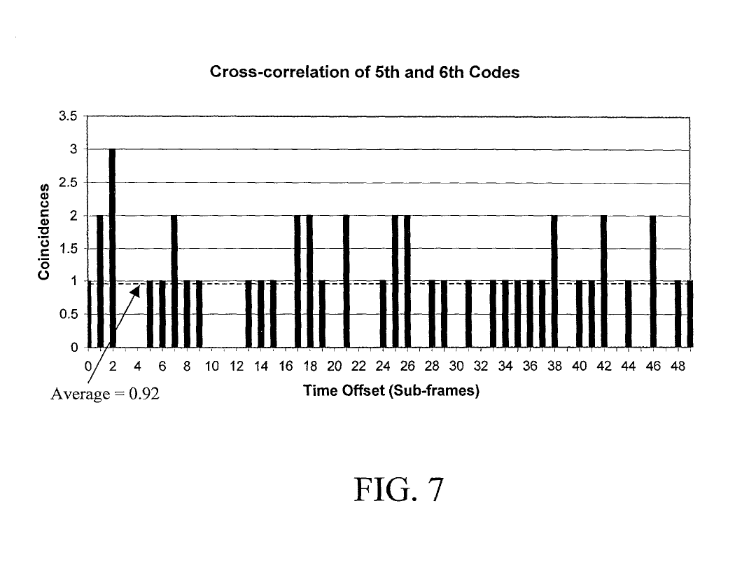

FIG. 6 presents the cross-correlation of the 5^{th} code 502e and the 6^{th} code 502f. In this figure, a pulse train produced by mapped the 6^{th} code 502f is shown correlated against instances of the 5^{th} code 502e that are incrementally shifted in time by offsets equal to multiples of the width of a subframe 514. The striped bars 602 are used to identify coincidences 604 that occur when the time period 504 produced with the 6^{th} code 502f is correlated against the shifted instances of a time layout 504 produced with the 5^{th} code 502e where coincidences 604 can be seen whenever a darkened subframe 514 appears behind a striped bar 602. The cross-correlation of these two codes 502e, 502f is depicted in FIG. 7, which shows the maximum number of coincidences 604 that occurs is 3 and the average number of coincidences is 0.92.

VI. Delay Codes

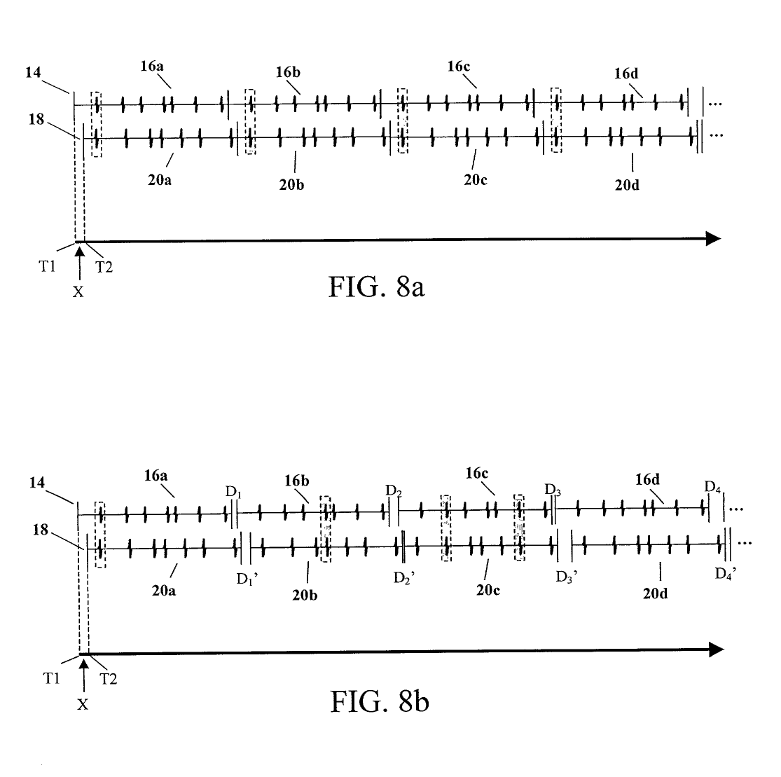

FIG. 8a illustrates two pulse train signals 14, 18 that are used in a UWB multiple access system for communication of information between users. The pulse train signal 14 comprises repeating pulse trains 16a-16d and the pulse train signal 18 comprises repeating pulse trains 20a-20d. Each pulse train has the same length and contains seven pulses. Relative to a receiver, pulse train 16a begins at time T1 and pulse train 20a begins at time T2, with an initial time offset X (T2-T1) between the pulse trains. The pulse trains of the pulse train signals 14 and 18 are generated by applying two different time-hopping codes that have the same code period. As stated before in connection with FIG. 1, pulse coincidences may occur between the repeating pulse trains of the pulse train signals 14 and 18. As shown in FIG. 8a, during the first instances of pulse trains 16a and 20a, the first pulses of these pulse trains coincide with each other. FIG. 8a also illustrates that this coincidence persists in that the first pulses of pulse trains 16b and 20b coincide, the first pulses of pulse trains 16c and 20c coincide, the first pulses of pulse trains 16d and 20d coincide, and so on. As the pulse trains repeat in time, the first pulse of the pulse trains of the two pulse train signals 14, 18 continue to coincide. The present invention eliminates persistence of such pulse coincidences by applying a delay code to one or both of the pulse train signals 14 and 18.

FIG. 8b illustrates delay codes applied to both of the pulse train signals 14 and 18. In FIG. 8b, a delay D₁ is inserted after pulse train 16a of the pulse train signal 14, and a delay D₁′ is inserted after pulse train 20a of the pulse train signal 18. Similarly, delays D₂, D₃, and D₄ are inserted after pulse trains 16b, 16c, and 16d, and delays D₂′, D₃′, and D₄′ are inserted after pulse trains 20b, 20c, and 20d. The duration of delays D₁-D₄ are specified by delay code elements of a first delay code that is applied to the pulse train signal 14, and the durations of the delays D₁′-D₄′ are specified by delay code elements of a second delay code that is applied to the pulse train signal 18. In this way, the inserted delays D₁-D₄ and D₁′-D₄′ vary the time offset between the coded signals 14 and 18. As can be seen in FIG. 8b, the position and number of the pulses of the two pulse trains that coincide, if any, varies as the time offset between them varies. Accordingly, as stated above, the average number of pulse coincidences over time between the two pulse train signals approaches the average correlation of the two time-hopping codes used to specify the time positioning of the pulse trains of the two pulse train signals. Furthermore, the received signal quality of either of the two pulse train signals 14 and 18 no longer depends on the initial time offset between them.

In a multi-user TM-UMB communication environment, many different transmitter-receiver pairs, or transceiver pairs, may operate in close proximity to each other. Typically, the number of pairs will vary and the specific devices communicating with each other will vary. In such an environment, an average data rate may be desirable. Accordingly, the sum of delay code elements of employed delay codes can be held to a constant. For example, in FIG. 8b, the sum of the delays specified by the two delay codes, D₁+D₂+D₃+D₄ and D₁+D₂′+D₃′+D₄′ could be made the same such that the delay code periods of the two delay codes is the same. Thus, a receiver of either pulse train signal 14 or 18 would receive data at the same average data rate.

In accordance with another embodiment of the present invention, multiple delay codes can be nested. A nested delay code specifies delays between repetitions of pulse trains that themselves are separated by delays specified by another delay code. For example, a first delay code having N delay code elements could specify delays after each of N instances of a pulse train, where the total time of the N pulse train instances and the N delays comprises a first delay code period. A second delay code having M delay code elements could specify delays after each of M instances of the first delay code period, where the total of the M first delay code periods and the M delays comprises a second delay code period. Furthermore, delay codes can be nested to as many levels that are desired. For example, a third delay code could specify delays after instances of the second delay code period defined in the previous example, a fourth delay code could specify delays after instances of this third delay code period, and so on.

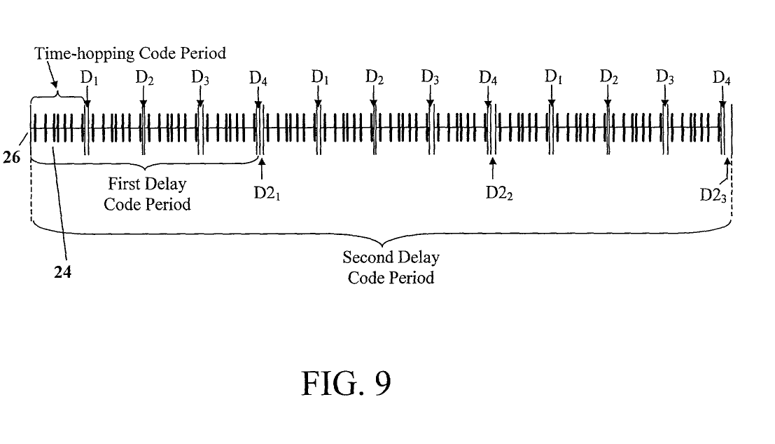

FIG. 9 shows a diagram of a pulse train signal that uses nested delay codes. As shown in FIG. 9, pulse train 24 repeats throughout the entire time layout of the pulse train signal 26. The pulse train 24 repeats 4 times with delays specified by the first delay code D₁-D₄ occurring after the four pulse train instances, respectively. After the 4th instance of the pulse train and its associated delay D₄, a delay D2₁ specified by the first delay code element of a second (nested) delay code is applied. The pulse train 24 repeats four more times with delays D₁-D₄ specified by the first delay code occurring after each of the four additional pulse train instances, respectively. Afterwards, a second delay D2₂ that is specified by the second delay code element of the second delay code is applied. The pulse train 24 repeats four more times with delays D₁-D₄ specified by the first delay code occurring after each of the four additional pulse train instances, respectively. Afterwards, a third delay D2₃ that is specified by the third delay code element of the second delay code is applied. This combination of twelve pulse train instances, three instances of each of the four delays D₁-D₄ specified by the first delay code, and the delays D2₁-D2₃ specified by the second delay code corresponds to the second delay code period, which could repeat, and which could be delayed in accordance with a third delay code, and so on. As such, delay code elements of a delay code can specify delays after code periods such as delays D₁-D₄ shown in FIG. 9. Also, delay code elements of a delay code can specify delays after delay code periods such as delays D2₁-D2₃ shown in FIG. 9. Furthermore, delay code elements of a delay code can specify delays after nested delay code periods.

Accordingly, the present invention improves channelization consistency of impulse radio systems operating in close proximity by causing the time offset between received pulse train signals to vary over time and thereby preventing the persistence of pulse coincidences. Additionally, by causing the time offset between received pulse train signals to vary over time, the average number of pulse coincidences per code period approaches an average provided by the correlation properties of the time-hopping codes used to specify the time positioning of the received pulse train signals. The average number of such pulse coincidences approaches zero as the average pulse repetition interval (PRI) increases. Furthermore, the present invention enables impulse radio systems to be designed for average correlation properties while at the same time accommodating the occasional occurrence of an undesired number of pulse coincidences per code period. In this way, the current invention enables larger families of time-hopping codes with less-restrictive correlation properties to be used. For example, pseudorandom codes can be applied that would otherwise be unacceptable to systems that require the maximum number of coincidences per code period to be no more than some limit. Accordingly, the current invention significantly increases the number of usable time-hopping codes.

VI. Dynamic Delay Codes

As described above, the number of pulse coincidences between pulse train signals depends on the time offset between them at a receiver. Accordingly, it may be desirable to determine and establish an optimal time offset between the two pulse train signals at the receiver. Therefore, in another embodiment of the invention, a received signal quality value for individual pulse trains or pulse train groups can be determined for different time offsets as established using delays specified by delay code elements of a delay code. The signal quality value may be some combination of a signal-to-noise ratio, bit-error-rate, signal strength, etc. Alternatively, a received signal quality value may pertain to a spectral property of the received signal. After a delay code is applied, an optimal time offset corresponding to the time delay(s) that resulted in the best signal quality value or one that meets a specified quality criterion is determined. The optimal time offset is then used for subsequent data transmissions.

To determine an optimal time offset, the delay code can be used, perhaps repeated several times, until signal quality measures corresponding to time offsets across the code period are available. In one embodiment, a delay code is repeated until a signal quality measure is determined to meet or exceed a desired threshold value, and the corresponding time offset is selected. In another embodiment, the delay code is used a predetermined number of times, M, determined, for example, based on the sum of the delays specified by the delay code elements of a delay code and the code period of the employed time-hopping code, where M multiplied by the sum of the delays is greater than or equal to the code period of the time-hopping code. The time offset having the best signal quality value is then selected from the signal quality measures for the time offsets produced by using the delay code the predetermined number of times. Under this arrangement, the best possible time offset is determined regardless of whether a threshold value is met. It should be noted that when a delay code having N elements is used M times, as many as NxM different time offsets could be available from which to select the most optimal time offset. However, if the sum of the delays specified by a delay code equals the code period, P, of the employed time-hopping code, or some multiple, only NxM mod P different time offsets are available to select from since they wrap around onto each other. Once an appropriate time offset is selected, the transmitter and receiver coordinate an appropriate delay of the pulse train signal such that the selected optimal time offset is achieved. After which, use of the delay code may be suspended indefinitely or until the signal quality measure falls below a threshold, after which the delay code may again be used.

In summary, communications are carried out in a typical TM-UWB communication system between a transmitter and a receiver. Both the transmitter and the receiver have a priori knowledge of the time-hopping code used to position the pulses of the pulse trains. This knowledge allows the receiver to know exactly when to detect the pulses. To improve received signal quality of the system, a delay code, for example that discussed above in regards to FIG. 4b, can be employed. As with the time-hopping code, both the transmitter and the receiver require a priori knowledge of the delay code to be used and how it is to be used. As is shown in FIG. 4b, by using a delay code, the number of pulse coincidences between two pulse train signals varies over time. Signal quality measures can be determined for the different time offsets and used to select an optimal time offset. In example 2 of FIG. 4b, the number of pulse coincidences for the first six complete pulse trains 402 varies from no pulse coincidences to two pulse coincidences, where no pulse coincidences occur between the two pulse trains 402, 404 after delaying the second pulse train 404 by the first delay D₁. Based on the six different time offsets Δt₁-Δt₅, and assuming other factors affecting the signal are negligible, a time offset equal to Δt₁=Δt₀+D₁ results in the best received signal quality. Thus, it is desired to delay the second signal 404 by a delay amount D₁ from the initial time offset. Similarly, had the first use of the third delay D3 resulted in the best received signal quality, the second signal 404 might be delayed by a delay amount D₁+D₂+D₃ from the initial time offset. Once an optimal time offset is determined, the transmitter and receiver coordinate the appropriate time delay required to achieve it and suspend use of the delay code.

Once an optimal time offset is determined and achieved by delaying the pulse train signal as appropriate, the received signal quality may change. For example, the transmitter and/or receiver may move with respect to each other, a non-intended signal may no longer interfere or begin to interfere, obstructions may be created or removed, etc. resulting in a change in signal quality. Accordingly, in one embodiment of the invention, the receiver continues to monitor the signal quality value after the best time offset is selected and achieved. If the signal quality value falls below a predetermined threshold value, the transmitter and receiver coordinate to again use the delay code. The process continues to determine a new optimal time offset, and so on. Thus, delay codes can be dynamically employed as needed to achieve optimal time offsets between pulse train signals at a receiver over time to provide superior signal quality in a changing environment.

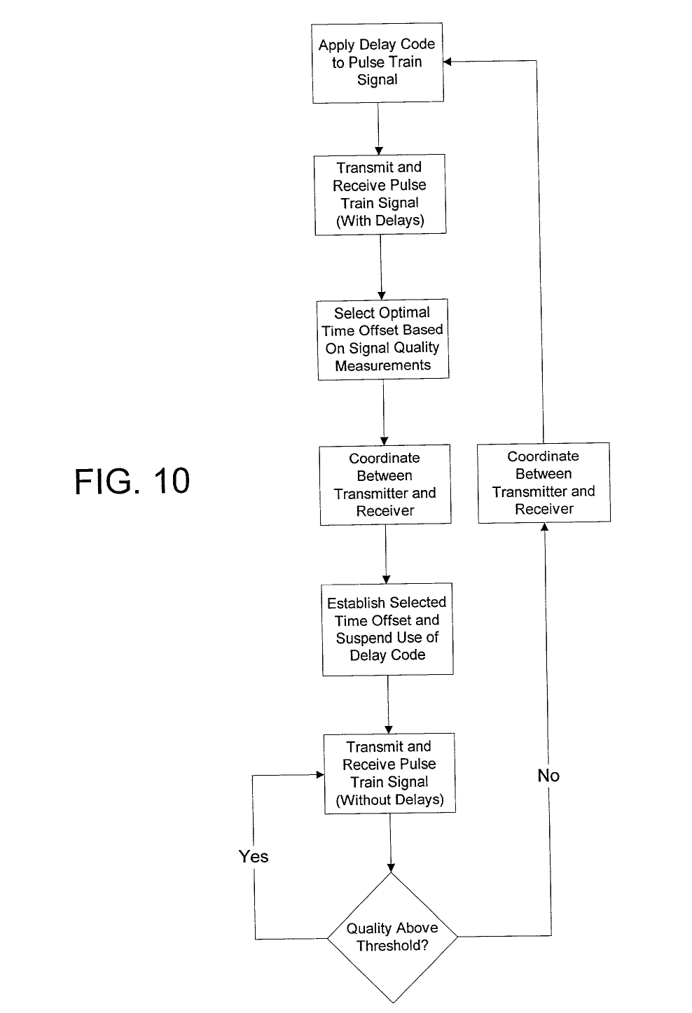

A process for dynamically employing delay codes to determine and achieve optimal time offsets over time is shown in FIG. 10. Initially, a delay code is applied to a pulse train signal comprising pulse trains defined by a time-hopping code. The pulse train signal is transmitted and received in accordance with the time-hopping code and the delay code. As the pulse train signal is received, the receiver measures the signal quality of the pulse trains for the different time offsets that result from the use of the delay code. The receiver determines the optimal time offset producing the best signal quality or a signal quality that meets or exceeds a predetermined quality threshold or criterion. The transmitter and receiver then coordinate the appropriate delay of the pulse train signal such that the selected time offset is achieved. After which, the pulse trains are transmitted and received without using the delay code. The pulse train signal is transmitted and received in accordance with the time-hopping code only. As the pulse train signal is received, the receiver measures the signal quality of the pulse trains. If the signal quality falls below a predetermined quality threshold, the receiver and the transmitter coordinate to again use the delay code, and the process repeats. Thus, a delay code can be dynamically used to determine the optimal time offset between two asynchronously generated pulse train signals at a receiver in order to maintain superior signal quality over time.

It should be noted that the ability of the present invention to dynamically determine optimal time offsets between pulse train signals arriving at a receiver can be used to support time-hopping code reuse. In other words, the same time-hopping code can be used by more than one transmitter-receiver pair, or pair of transceivers, as long as each pair uses the same code with a different time offset. In order to implement such code reuse, a communications protocol may be used to ensure the received signal is the intended signal. For example, in an environment where multiple pulse train signals are specified by the same time hopping code, after successfully acquiring a given pulse train signal, sender identification data included with the received pulse train signal can be examined to determine whether the received signal is the intended signal. If the received signal is not the intended signal, a different time offset can be selected.

Furthermore, the current invention enables larger families of time-hopping codes having less-restrictive correlation properties, for example, pseudorandom time-hopping codes, to be used. By dynamically determining optimal time offsets between such codes, unacceptable numbers of pulse coincidences that are possible with the lesser quality codes can be avoided. Thus, the present invention significantly increases the number of usable time-hopping codes.

SPECTRAL BENEFITS OF DELAY CODES

By varying the time offset between asynchronous pulse train signals arriving at a receiver, the present invention reduces the periodicity of a pulse train signal and thereby has a smoothing effect on its energy spectrum. Specifically, where the code period of conventional pulse train signals repeats at a constant frequency, delay codes result in the code period repeating at varied frequencies. Furthermore, nesting delay codes results in additional spectral smoothing.

The dynamic delay codes embodiments of this invention enable time-hopping codes to be used that meet less-stringent correlation properties including, for example, pseudorandom time-hopping codes that typically have superior spectral properties than designed time-hopping codes.

GENERATING DELAY CODES

A delay code can be generated using any of the numerical code generation techniques described previously for generating time-hopping codes. Pseudorandom code generation techniques, in particularly, can be used to generate delay codes that eliminate pulse coincidence persistence, reduce periodicity, and are least likely to synchronize.

A delay code element may be a number representing a time delay value, for example a delay code element having a value of 1.5 could represent a one and one half picosecond time delay. Alternatively, a delay code element may be a symbol, for example, an integer number that maps to a time delay value. For example, a delay code element value of 1 could represent the first of ten possible discrete time delay amounts. Similarly, the ten possible discrete time delay amounts could be assigned the symbols A through J, or some other predefined symbols. Furthermore, a delay code element value could be mapped to a memory location that contains a time delay value. Generally, a variety of code mapping approaches can be employed like those described for time-hopping codes in a co-owned patent application entitled “A METHOD FOR SPECIFYING PULSE CHARACTERISTICS USING CODES”, U.S. patent application Ser. No. 09/638,153 (Attorney Docket No. 28549-165557), which is hereby incorporated by reference. Alternative code mapping methods could also be employed without departing from the scope of the invention.

Furthermore, when generating delay codes, delay code-related rules can be applied to attain desired characteristics. Such a rule may for example require that the sum of all delays specified by a delay code be maintained as a constant for all delay codes that are a member of a delay code family. A delay code that satisfies the rule can be created using a pseudorandom code generation technique for all delay code elements except the last one, for example. The last code element, which produces the desired constant sum, is then calculated to be equal to the difference of the desired sum and the total of the delays specified by the other delay code elements. Another rule may for example require that a constant delay code length be enforced for all delay codes of a delay code family. Similarly, a constant delay code period can be maintained if both a constant delay code length and a constant delay sum are enforced. Delay codes of a delay code family may be generated such that the sum of the delays is purposely different for each delay code. A delay-code-related rule may also require the sum of the delays to be greater than the code period of the time-hopping codes with which they are to be used. With this approach, a single instance of the delay code would vary the time offset across the full code period. Generally, a variety of different delay-code-related rules can be established when generating delay codes to produce desired characteristics without departing from the scope of the invention.

An Exemplary Impulse Radio System that Uses Delay Codes

The exemplary impulse radio system, described in connection with FIGS. 2 and 3, comprises an exemplary impulse radio transmitter and an exemplary radio receiver. To use delay codes, the transmitter 202, depicted in FIG. 2, can store the delay code(s) in the code source 212 along with the time-hopping code such that the time-hopping code and delay code(s) can be used together to output the code signal 214. Similarly, to use delay codes, the receiver 302, depicted in FIG. 3, can store the delay code(s) in the code source 322 along with the time-hopping code such that the time-hopping code and delay code(s) can be used together to output the code signal 324.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

1. A method for transmitting and receiving a pulse train signal, comprising:
generating a plurality of pulse trains, wherein each pulse train comprises at least one pulse having at least one predefined pulse characteristic; and
inserting a time delay between two pulse trains of said plurality of pulse trains, wherein the time delay results in at least one of:
an averaging of the number of coincidences between the pulses of the plurality of pulse trains and pulses of another plurality of pulse trains at a receiver; and
satisfying a received signal quality criterion.

2. The method of claim 1, wherein the received signal quality criterion is at least one of:
a received signal quality measurement that meets a signal quality threshold; and
a best received signal quality measurement of a plurality of signal quality measurements.

3. The method of claim 1, wherein the time delay is specified by at least one code element of at least one delay code.

4. The method of claim 1, wherein a predefined pulse characteristic comprises at least one of:
a time position,
a pulse amplitude;
a pulse width;
a pulse polarity; and
a pulse type.

5. The method of claim 4, wherein the time position is specified in accordance with a code element of a time-hopping code.

6. The method of claim 5, wherein a delay code comprises one or more code elements that specify time delays to be inserted between any one of:
two time-hopping code periods;
two delay code periods, and
two nested delay code periods.

7. The method of claim 1, further comprising:
measuring received signal quality for a plurality of pulse trains based on at least one inserted time delay;
selecting a received signal quality measurement that satisfies a received signal quality criterion; and
delaying a pulse train by an amount of time equal to a sum of any inserted time delays that satisfy the received signal quality criterion.

8. The method of claim 7, wherein the received signal quality measurement is a function of at least one of a:
Signal strength,
Bit-error-rate,
Signal-to-noise ratio; and
Spectral property of the received signal.

9. The method of claim 7, wherein at least one time delay is inserted when a selected received signal quality measurement falls below a threshold.

10. The method of claim 7, wherein at least one time delay is periodically inserted between two adjacent pulse trains to satisfy the received signal quality criterion.

11. The method of claim 3, wherein the at least one delay code is generated using at least one of:
a designed code generation technique, and
a pseudorandom code generation technique.

12. The method of claim 11, wherein said designed code generation technique comprises at least one of:
a Welch-Costas code generation technique;
a Golomb-Costas code generation technique;
a Quadratic Congruential code generation technique;
a Linear Congruential code generation technique; and
a Hyperbolic Congruential code generation technique.

13. The method of claim 11, wherein said pseudorandom code generation technique comprises at least one of:
a linear congruential pseudorandom number generator technique.
an additive lagged-Fibonacci pseudorandom number generator technique;
a linear feedback shift register pseudorandom number generator technique;
a lagged-Fibonacci shift register pseudorandom number generator technique;
a chaotic code pseudorandom number generator technique; and
an optimal Golomb ruler code pseudorandom number generator technique.

14. The method of claim 11, wherein at least one of a delay code length, a delay code period, and a sum of the time delays specified by code elements of a delay code of a plurality of delay codes is a constant value.

15. The method of claim 11, wherein a sum of the time delays specified by code elements of any delay code of a plurality of delay codes is not equal to a sum of delays specified by code elements of any other delay code of the plurality of delay codes.

16. The method of claim 11, wherein a sum of the time delays specified by code elements of a delay code of a plurality of delay codes is greater than a code period of a time hopping code.

17. The method of claim 3, wherein the at least one code element of the at least one delay code is at least one of:
a time delay value;
a symbol that maps to a time delay value; and
a symbol that maps to a memory location.

18. A method for transmitting and receiving a plurality of time-varied signals, comprising:
generating a plurality of time-varied signals, and
inserting a time delay between two time-varied signals of said plurality of time-varied signals, wherein the time delay results in at least one of:
an averaging of the number of coincidences between time-varied signals of said plurality of time-varied signals and time-varied signals of another plurality of time-varied signals at a receiver; and
satisfying a received signal quality criterion.

19. The method of claim 18, wherein time-varied signals consists of:
time-hopping signals;
frequency hopping signals;
time-division multiple access signals;
time-division code-division multiple access signals; and
orthogonal frequency division multiple access signals.

20. The method of claim 18, wherein the received signal quality criterion is at least one of:
a signal quality measurement that meets a signal quality threshold; and
a best signal quality measurement of a plurality of signal quality measurements.

21. The method of claim 18, further comprising, wherein the time delay is specified by at least one code element of at least one delay code.

22. The method of claim 18, wherein a characteristic of the plurality of time-varied signals is varied in accordance with a code element of a time-varying code.

23. The method of claim 22, wherein said time-varying code specifies a characteristic of the plurality of time-varied signals within a time-varying code period.

24. The method of claim 23, wherein the time-varying code is a delay code having one or more code elements that specify time delays to be inserted between any one of:
two time-varying code periods;
two delay code periods, and
two nested delay code periods.

25. The method of claim 18, further comprising:
measuring received signal quality for a plurality of time-varied signals based on the time delays;
selecting a received signal quality measurement that satisfies a received signal quality criterion; and
delaying a time-varied signal by an amount of time equal to the sum of the time delays that satisfies the received signal quality criterion.

26. The method of claim 25 wherein the received signal quality measurement is a function of at least one of a:
Signal strength,
Bit-error-rate,
Signal-to-noise ratio; and
Spectral property of the received signal.

27. The method of claim 25, wherein at least one time delay is inserted when a selected received signal quality measurement falls below a threshold.

28. The method of claim 25, wherein at least one time delay is periodically inserted between two adjacent pulse trains to satisfy the received signal quality criterion.

29. The method of claim 21, wherein a delay code is generated using at least one of:
a designed code generation technique, and
a pseudorandom code generation technique.

30. The method of claim 29, wherein said designed code generation technique comprises at least one of:
a Welch-Costas code generation technique;
a Golomb-Costas code generation technique;
a Quadratic Congruential code generation technique;
a Linear Congruential code generation technique; and
a Hyperbolic Congruential code generation technique.

31. The method of claim 29, wherein said pseudorandom code generation technique comprises at least one of:
a linear congruential pseudorandom number generator technique.
an additive lagged-Fibonacci pseudorandom number generator technique;
a linear feedback shift register pseudorandom number generator technique;
a lagged-Fibonacci shift register pseudorandom number generator technique;
a chaotic code pseudorandom number generator technique; and
an optimal Golomb ruler code pseudorandom number generator technique.

32. The method of claim 29, wherein at least one of a delay code length, a delay code period, and a sum of the time delays specified by the code elements of a delay code of a plurality of delay codes is a constant value.

33. The method of claim 29, wherein a sum of time delays specified by code elements of any delay code of a plurality of delay codes is not equal to a sum of delays specified by code elements of any other delay code of the plurality of delay codes.

34. The method of claim 29, wherein a sum of the time delays specified by code elements of a delay code of a plurality of delay codes is greater than a code period of a time-varying code.

35. The method of claim 21, wherein the at least one code element of the at least one delay code is at least one of:
a time delay value;
a symbol that maps to a time delay value; and.
a symbol that maps to a memory location.

36. An impulse transmission system for communicating pulses having at least one predefined pulse characteristics, comprising:
an Ultra Wideband Transmitter; and
an Ultra Wideband Receiver;
wherein said Ultra Wideband Transmitter inserts at least one time delay specified by at least one code element of at least one delay code between two pulse trains of a plurality of pulse trains.

37. The impulse transmission system of claim 36, wherein a predefined pulse characteristic comprises at least one of:
a time position,
a pulse amplitude;
a pulse width;
a pulse polarity; and
a pulse type.

38. The impulse transmission system of claim 37, wherein the time position is specified in accordance with a code element of a time-hopping code.

39. The impulse transmission system of claim 38, wherein a delay code comprises one or more code elements that specify time delays to be inserted between any one of:
two time-hopping code periods;
two delay code periods, and
two nested delay code periods.

40. The impulse transmission system of claim 36, wherein:
said Ultra Wideband Receiver measures received signal quality for a plurality of pulse trains based on the time delays and
selects a received signal quality measurement that satisfies a received signal quality criterion; and
said Ultra Wideband Transmitter delays a pulse train by an amount of time equal to a sum of time delays that satisfies the received signal quality criterion.

41. The impulse transmission system of claim 40, wherein a received signal quality measurement is a function of at least one of a:
Signal strength,
Bit-error-rate,
Signal-to-noise ratio; and
Spectral property of the received signal.

42. The impulse transmission system of claim 40, wherein at least one time delay is inserted when a selected received signal quality measurement falls below a threshold.

43. The impulse transmission system of claim 40, wherein at least one time delay is periodically inserted between two adjacent pulse trains to satisfy the received signal quality criterion.

44. A multiple access system for transmitting and receiving a plurality of time-varied signals, comprising:
a Transmitter; and
a Receiver;
wherein said Transmitter generates a plurality of time-varied signals, and inserts a time delay specified by at least one code element of at least one delay code between two time-varied signals of said plurality of time-varied signals.

45. The multiple access system of claim 44, wherein time-varied signals consists of:
time-hopping signals;
frequency hopping signals;
time-division multiple access signals;
time-division code-division multiple access signals; and
orthogonal frequency division multiple access signals.

46. The multiple access system of claim 44, wherein a characteristic of a plurality of time-varied signals is varied in accordance with a time-varying code.

47. The multiple access system of claim 46, wherein said time-varying code specifies a characteristic of the plurality of time-varied signals within a time-varying code period.

48. The multiple access system of claim 47, wherein a delay code comprises one or more code elements that specify time delays inserted between:
two time-varying code periods;
two delay code periods, and
two nested delay code periods.

49. The multiple access system of claim 44, wherein:
said Receiver measures a received signal quality for a plurality of time-varied signals based on the time delays and
selects a received signal quality measurement that satisfies a received signal quality criterion; and
said Transmitter delays a time-varied signal by an amount of time equal to a sum of time delays that satisfies the received signal quality criterion.

50. The multiple access system of claim 49, wherein the received signal quality measurement is a function of at least one of a:
Signal strength,
Bit-error-rate,
Signal-to-noise ratio; and
Spectral property of the received signal.

51. The multiple access system of claim 49, wherein at least one time delay is inserted when a selected received signal quality measurement falls below a threshold.

52. The multiple access system of claim 49, wherein at least one time delay is periodically inserted between two adjacent pulse trains to satisfy the received signal quality criterion.
